(19) United States
(12) Patent Application Publication
(10) Pub. No.: US 2004/0001213 A1
(43) Pub. Date: Jan. 1, 2004

(54) Image manipulation apparatus and method

(76) Inventor: Terrence Michael Shannon, Kuna, ID (US)

Correspondence Address: HEWLETT-PACKARD COMPANY, Intellectual Property Administration, P.O. Box 272400, Fort Collins, CO, 80527-2400, US

(21) Appl. No.: 10/180,370

(22) Filed: Jun. 26, 2002

(51) Int. Cl. G06F 3/12; G06F 15/00; G06F 9/44; G06F 13/10

(52) U.S. Cl. 358/1.13; 358/1.15; 710/16; 709/321; 717/171

(57) ABSTRACT

An image manipulation apparatus and method includes, in a printer system including at least one printer, with a driver and a host computer operating system, software on the driver for manipulating rasterized images. The software is attached to a rasterized image and sent to the printer via the host computer operating system. In further aspects of the invention, a compression device, interrogation software, and an analysis device are provided for compressing the rasterized image, interrogating the printer and host computer operating system for specific parameters, and for analyzing the rasterized image from a set including: image content, image color, best compression method and compressed image size.

### FIELD OF THE INVENTION

This invention relates to an image manipulation apparatus and method. In one embodiment in particular, the invention relates to an image manipulation apparatus and method in a printer system including at least one printer, with a driver and a host computer operating system, wherein software is provided on the driver for manipulating rasterized images and the software is attached to the rasterized image and sent to a printer via the host computer operating system.

### BACKGROUND OF THE INVENTION

Many difficulties arise in prior art printer systems stemming from the fact that printer software is a permanent component of prior art printers. This forces a tight coupling between the printer and the driver and forces the driver to describe a page image in constraints imposed by the language of the printer. As a result, prior art software is very difficult to upgrade or “bug fix” in the field.

It should be noted that prior art “printer” systems include multi-function peripherals (MFPs) which are devices that are capable not only of printing, but of copying, scanning and so forth. In any event, prior art software for printers is complex and expensive, includes by necessity multiple device fonts, requires an onboard memory and complicates the processor.

Thus, there is a need in the art for providing an apparatus and method of providing images to printers/MFPs that is flexible, scalable, and inexpensive.

### SUMMARY OF THE INVENTION

Accordingly, the image manipulation apparatus and method of the present invention includes in a printer system including at least one printer, with a driver and a host computer operating system, software on the driver for manipulating rasterized images. A rasterized image is created and the software is attached to the rasterized image and sent to the printer via the host computer operating system. In a further aspect of the invention, a compression device is provided for compressing the rasterized image.

In another embodiment of the invention, in a printer system with at least one printer, with a driver and a host computer operating system, a computer program product for manipulating an image sent to the printer includes manipulation instructions for manipulating rasterized images. The invention further includes instructions for rasterizing images and instructions for attaching the manipulation instructions to a rasterized image and sending the manipulation instructions and the rasterized image to the printer.

### DESCRIPTION OF THE DRAWINGS

FIG. 1 is a schematic diagram of the image manipulation apparatus according to an embodiment of the present invention; and

FIG. 2 is a flow diagram of the method according to an embodiment of the present invention.

### DETAILED DESCRIPTION OF THE INVENTION

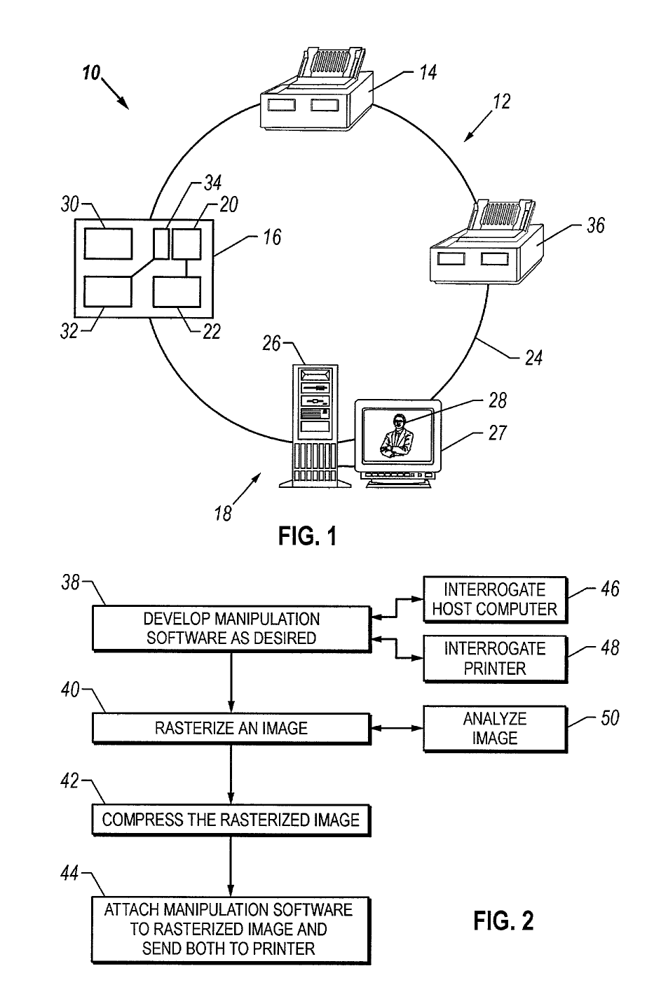

The preferred embodiment of the present invention is illustrated by way of example in FIGS. 1-2. With specific reference to FIG. 1, the image manipulation apparatus 10 of the present invention includes in a printer system 12 with at least one printer 14, a driver 16, a host computer operating system 18, and software 20 on the driver 16 for manipulating rasterized images 22. In a preferred embodiment, software 20 is attached to the rasterized image 22 and sent to printer 14 via host computer operating system 18. Driver 16, printer 14, and host computer operating system 18 are connected by network 24. Network 24 may be any type of network, electronic, infrared, or the like, including the Internet, now known or hereafter developed. Host computer operating system 18 includes a computer processor 26, as is known in the art, connected to monitor 27 for displaying images 28, and the like.

FIG. 1 shows image 28 as a human figure representing one type of visual image anticipated by the invention. Certainly, image 28 may be printed matter only or a combination of images and printed matter. Also, image 28 may be in color or monochrome, or some combination thereof.

As utilized herein, the term “rasterized images” 22 refers to raster graphics. Raster graphics are computer graphics in which an image is composed of an array of pixels arranged in rows and columns. This array of pixels is also known as a bitmap. The bitmap is characterized by the width and height of the image in pixels and the number of bits per pixel which determines the number of shades of gray or colors it can represent, all as known in the art. Likewise, software 20 and device driver 16 have the meaning and definitions as commonly known in the art.

With continued reference to FIG. 1, the image manipulation apparatus 10 of the present invention includes, in a preferred embodiment, compression device 30. Compression device 30 is any software/hardware now known or hereafter developed for compressing images. Compression device 30 is utilized to compress rasterized image 22 prior to sending rasterized image 22 to printer 14. In this embodiment, software 20 has a simple job of decompressing rasterized image 22 upon receipt and sending the resulting scanlines to the video data stream of the printer 14, as known in the art and not shown. This requires very simple software 20. In fact, software 20 is small enough that it is practical to attach the software 20 to the data stream including the rasterized images 22 and to send it directly to a target printer 14. At that point, printer 14 uses the downloaded software 20 to decode the attached page/image data. The software 20 may be conformed to handle monochrome or color or an assortment of images as is known in the art.

In a further embodiment, interrogation software 32 is provided, preferably on driver 16. Interrogation software 32 is connected with printer 14 through host computer operating system 18 through network 24 as previously described. Interrogation software 32 is configured to determine host computer operating system 18 and printer 14 constraints/operating parameters, such as, for example only, operating system processing speed and printer connection speed. Additionally, interrogation software 32 is connected to host computer operating system 18 through network 24 and thereby is enabled to receive upgraded software algorithms and the like thereby providing automatic driver 16 and software 20 upgrades. Interrogation software 32 is connected, therefore, to software 20 on driver 16.

In a still further embodiment, analysis device 34 is connected to software 20 on driver 16. Analysis device 34 is provided for examining images 28 from a set including: image content, image in color or monochrome, best compression method for the image, and the resulting compressed image size, among other things, for example.

While software 20, compression device 30, interrogation software 32, and analysis device 34 have been described as separate, discrete systems, it should be clear to those of ordinary skill in the art that they could all be subsumed in a single software 20 product. Likewise, driver 16, may physically be located apart from host computer operating system 18, as illustrated, or reside physically thereon. Still further, FIG. 1 illustrates the inclusion of MFP 36. MFP 36 is any multifunctional peripheral now known or hereafter developed that includes, for the purposes of this invention, a printer 14 of some type.

Referring now to FIG. 2, a flow chart of the method steps of image manipulation system 10 according to an embodiment of the present invention is illustrated. To begin with, in step 38 a user develops manipulation software 20 as desired. Next, in step 40 an image 28 is rasterized. Thereafter, in a preferred embodiment, the rasterized image 22 is compressed at step 42. Finally, the compressed, rasterized image 22 is attached to manipulation software 20 and both are sent to printer 14. At that point in step 44, printer 14, utilizing software 20 decompresses the rasterized image 22 as previously discussed.

Additionally, at step 46, interrogation software 32 is utilized to interrogate host computer 18, network 24, and the like as previously discussed for the current download for software 20 as desired. Additionally, at step 48, interrogation software 32 interrogates host computer operating system 18 and printer 14 to determine their operating parameters, again as previously discussed. At step 50, analysis device 34 analyzes images 28 from a set including image content, image in color or monochrome, best compression method, and compressed image size, for example only and not by way of limitation. All this information is available at step 40 prior to compression of the rasterized image at step 42.

It should be obvious that software 20 could be sent to printer 14 in printer system 12 either at the time that the printer 14 is powered up, at the time that driver 16 loads, at the beginning of a print job, or at the beginning of each page of images. Again, driver 16 renders image 28, a figure/printed text/etc., in a raster format, creating a rasterized image 22 in pixels that are ready to print. Driver 16 “decides” what compression method will work best for a particular image 28, based on any set of criteria desired, including the analysis set described above, for example. Once the desired criteria are known and/or selected, driver 16 creates an algorithm in the form of software 20. Again, software 20 may preferably include compression device 30. At that point, software 20 is attached to rasterized image 22 and sent to printer 14 over the available data channel, network 24 in the illustration.

The software 20 may have a version number. If so, if printer 14 has a bi-directional connection, the driver 16 queries the printer 14 to see if the current software 20 version is already present prior to download, and, if so, driver 16 does not send the duplicate software 20. In the case where there is no bi-directional connection, the driver 16 attaches the software 20 to the beginning of each page of rasterized images 22. In that case, when the printer 14 receives the rasterized images 22, printer 14 examines the software 20 version and decides to download the software 20 or to just discard that portion of the page data because the software 20 is a duplicate of the version already loaded.

In sum, because the image manipulation apparatus and method 10 of the present invention uses hardware ready bits (raster) as a page description, software 20 may be a very simple and small amount of code. Software 20 in one embodiment is, essentially, a raster decompressor. As a result, the image manipulation apparatus and method 10 of the present invention enables driver 16 to send the software 20 to the printer 14. Driver 16 is capable of offering the best available compression algorithms for describing each page of text or images. Further, driver 16 may automatically upgrade existing printer software as new algorithms become available. Another practical effect of the invention is that driver 16 and the printer 14 are much more independent from the host computer operating system 18. Still further, applicant's image manipulation apparatus and method 10 is scalable from high-end computers, through traditional PCs, down to handheld PDAs and other small hybrid devices. Image manipulation apparatus and method 10 of the present invention offers significant cost reductions for the manufacturing of printers 14 by reducing the need for complex software/firmware, eliminating device fonts, reducing the need for onboard memory, and simplifying the processor so that an ASIC can be substituted, for example.

The description of the present embodiments of the invention have been presented for purposes of illustration but are not intended to be exhaustive or to limit the invention to the form disclosed. Many modifications and variations will be apparent to those of ordinary skill in the art. As such, while the present invention has been disclosed in connection with the preferred embodiment thereof, it should be understood that there may be other embodiments which fall within the spirit and scope of the invention as defined by the following claims.

What is claimed is:

1. A printer driver having instructions for rasterizing an image, manipulating the rasterized image, and sending the instructions for manipulating the rasterized image to the printer along with the rasterized image.

2. The printer driver of claim 1, wherein the printer driver also includes instructions for compressing the rasterized image and the instructions for manipulating the rasterized image comprise instructions for decompressing the compressed rasterized image.

3. The printer driver of claim 1, wherein the printer driver also includes instructions for interrogation of a host computer for operating system processor speed and of a printer for printer connection speed.

4. The printer driver of claim 1, wherein the printer driver also includes instructions for analyzing the image from a set including: image content, image in color or monochrome, best compression method and compressed image size.

5. In a printer system including at least one printer, with a driver and a host computer operating system, an image manipulation apparatus, the apparatus comprising:
(a) software on said driver for manipulating rasterized images; and
(b) the apparatus configured to attach said software to said rasterized image and to send said software to said printer via said host computer operating system.

6. The apparatus of claim 5 further comprising a compression means for compressing said rasterized image.

7. The apparatus of claim 5 wherein said software is conformed to manipulate color rasterized images.

8. The apparatus of claim 5 further comprising interrogation software for interrogating the host computer operating system for processor speed and the printer for printer connection speed.

9. The apparatus of claim 5 wherein said software includes an analysis means for examining said image from a set including: image content, image in color or monochrome, best compression method, and compressed image size.

10. In a system having a printer and a computer linked to the printer, a method for preparing print data comprising:
(a) the computer rasterizing an image;
(b) the computer compressing the rasterized image; and
(c) the computer sending the compressed rasterized image to the printer along with instruction for decompressing the compressed rasterized image.

11. The method of claim 10 further comprising the step of the computer determining computer processor speed and printer connection speed.

12. The method of claim 10 further comprising the step of the computer examining the image from a set including: image content, image in color or monochrome, best compression method and compressed image size.

13. In a printer system with at least one printer, with a driver and a host computer operating system, a method of manipulating an image sent to the printer, the method comprising the steps of:
(a) providing manipulation software on the driver for manipulating rasterized images;
(b) rasterizing an image;
(c) providing a compression means for compressing the rasterized image;
(d) providing interrogation software on the driver connected with the printer through the host computer operating system for determining printer parameters;
(e) determining the printer parameters;
(f) compressing the rasterized image;
(g) attaching the manipulation software to the compressed rasterized image; and
(h) sending the compressed rasterized image to the printer.

14. The method of claim 13 wherein step d) includes the steps of providing a connection to a network through the host computer operating system and accessing new driver and software upgrades on the network.

15. The method of claim 13 further comprising the step of providing an analysis means on the driver for examining the image from a set including:
image content, image color, best compression method for the image, and compressed image size.

16. In a printer system with at least one printer, with a driver and a host computer operating system, a computer program product for manipulating images sent to the printer, the computer program product comprising:
(a) manipulation instructions for manipulating a rasterized image;
(b) instructions for rasterizing images; and
(c) instructions for attaching the manipulation instructions to a rasterized image and sending the manipulation instructions and the rasterized image to the printer.

17. The computer program product of claim 16 further comprising instructions for compressing and decompressing the rasterized image.

18. The computer program product of claim 16 further comprising instructions for interrogating the host computer and the printer to determine the operating system processor speed and the printer connection speed.

19. The computer program product of claim 16 further comprising instructions for examining the image from a set including: image content, image color, best compression method, and compressed image size.

20. The computer program product of claim 16 further comprising instructions for connecting to a network through the host computer operating system and accessing new driver and software upgrades on the network.
